(19) United States
(12) Patent Application Publication
(10) Pub. No.: US 2002/0152124 A1
(43) Pub. Date: Oct. 17, 2002

(54) Methods and systems for remote point-of-sale funds transfer

(76) Inventors: Javier Guzman, Vienna, VA (US); Eric Scott Lancaster, Arlington, VA (US); Robert W. Stradtman, Arlington, VA (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/828,830

(22) Filed: Apr. 10, 2001

(51) Int. Cl. G06F 17/60

(52) U.S. Cl. 705/16; 705/39

(57) ABSTRACT

Systems and methods consistent with the principles of the present invention address the need to more conveniently and efficiently transfer value to a card issuer. Specifically, in systems and methods consistent with the invention, funds to be applied as a payment to an account are received at a point-of-sale location from a cardholder. These funds may include cash, check, credit card, money order, cashier's check, or other cash equivalent. A transaction message, indicating a payment transaction and a payment amount, is sent from the point-of-sale location to the card issuer. The card issuer then verifies the account information indicated in the transaction message. When the point-of-sale location then receives an indication that the payment amount was applied to the account, the point-of-sale location forwards the payment to the card issuer.

### BACKGROUND OF THE INVENTION

1. Field of the Invention

The present invention relates generally to credit card systems and, more particularly, to systems and methods for transferring funds to a credit card issuer from a remote point-of-service location.

2. Background of the Invention

Credit card products have become so universally well known and ubiquitous that they have fundamentally changed the manner in which financial transactions and dealings are viewed and conducted in society today. Credit card products are most commonly represented by plastic card-like members that are offered and provided to customers through credit card issuers (such as banks and other financial institutions). With a credit card, an authorized customer is capable of purchasing services and/or merchandise without an immediate, direct exchange of cash.

In the current credit processing system, the customer presents a credit card or credit card number to a merchant. The merchant processes and transmits information, including credit card information and purchase amount, through an established system of electronic clearances and settlements to complete payment. The card issuer is notified of the pending transaction and is given an opportunity to approve it. If approved, a series of clearances and settlements among interchange participants (namely, the merchant, the acquiring bank, the card issuer, and/or the processing institution) results in the card issuer reimbursing the other participants in the process for the cost of the purchase. The card issuer then invoices the customer for the amount of the purchase and may extend credit such that the customer can pay the amount of the purchase over time.

In general, the card issuer provides the customer with a monthly or otherwise periodic statement. The customer may have the option to either fully pay the outstanding balance, or as a matter of necessity or choice, may defer at least a portion of the balance for later payment with accompanying interest or finance charges for the period during which payment of the outstanding debt is deferred. Following receipt of the statement, the customer generally mails a check or money order to the card issuer This process can be inefficient and time-consuming. Further, because of the unknown delay inherent in mail delivery, the customer does not known when the payment will be applied toward the account. Thus, the customer may not be able to effectively manage his available credit line.

While the Internet and automated bill payment schemes provide a potential solution to these problems of credit line management and efficient bill payment, these options are not available to the portion of the population lacking computers and/or Internet service. Additionally, many customers do not sufficiently trust the security of the Internet and will not use this type of service. Other customers do not have a required bank account to make a payment to their credit card over the Internet. For such customers to make a payment, they must first obtain a money order. This, however, is inefficient, time-consuming, and expensive.

In view of the foregoing, there is presently a need for an improved system and method for making credit card payments to a card issuer. For example, a need exists for a method to transfer value to a card issuer that is fast and efficient, for both the customer and the card issuer. Further, there is a need for a method to transfer value that does not require Internet access and/or a bank account.

### SUMMARY OF THE INVENTION

Systems and methods consistent with the principles of the present invention address the need to more conveniently and efficiently transfer funds to a card issuer. Specifically, in systems and methods consistent with the invention, funds to be applied as a payment to an account are received at a point-of-sale location from a cardholder. These funds may include cash, check, credit card, money order, cashier's check, or other cash equivalent. Additionally, a credit card may be received at the point-of-sale location to identify the account. A transaction message, indicating a payment transaction and a payment amount, is sent from the point-of-sale location to the card issuer. The point-of-sale location then receives an indication that the payment amount was applied to the account. Finally, the payment amount is forwarded from the point-of-sale location to the card issuer. Alternatively, the payment amount may be forwarded from the point-of-sale location to a financial institution that manages credit transactions for the point-of-sale location. The financial institution then forwards the payment amount to the card issuer.

In another embodiment consistent with the present invention, methods and systems are provided for receiving funds from a point-of-sale location as payment to an account owned by a card issuer. First, the card issuer receives a transaction message from the point-of-sale location, indicating a payment transaction and a payment amount. The card issuer then verifies the account information indicated in the transaction message. The card issuer then sends an indication to the point-of-sale location indicating that the transaction was approved and the payment amount was applied to the account.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

Both the foregoing general description and the following detailed description are exemplary and are intended to provide further explanation of the invention as claimed.

### BRIEF DESCRIPTION OF THE DRAWINGS

The accompanying drawings, which are incorporated in and constitute a part of this specification, illustrate various embodiments of the present invention and, together with the description, serve to explain the principles of the invention. In the drawings:

FIG. 1 illustrates an exemplary system environment in which the features of the present invention may be implemented;

FIG. 2 is an exemplary flow chart of a method, consistent with the principles of the present invention, for transferring value from a remote POS location; and

FIG. 3 is an exemplary flow chart of a method, consistent with the principles of the present invention, for receiving value transferred from a remote POS location.

### DESCRIPTION OF THE EMBODIMENTS

Systems and methods consistent with the principles of the present invention address the need to more conveniently and efficiently transfer funds to a card issuer by permitting a customer to transfer funds to the card issuer from a point-of-sale location, such as a retail merchant. The customer presents a credit card, associated with the card issuer, as well as funds at a point-of-sale (POS) location. The funds presented may include cash, check, credit card, money order, cashier's check, or other cash equivalent. Because the funds presented may include cash, customers with insufficient bank accounts to utilize Internet or other direct payment systems are provided with a convenient and efficient way to make payments to a credit card account.

Following presentment of funds, a transaction message, indicating a payment transaction and a payment amount, is sent from the POS location to the card issuer. The POS location then receives an indication that the payment amount was applied to the account. Finally, the payment amount is forwarded from the point-of-sale location to the card issuer. Because the crediting of the customer's account is done at or near the time of the presentment of funds, the customer may better manage the credit card account.

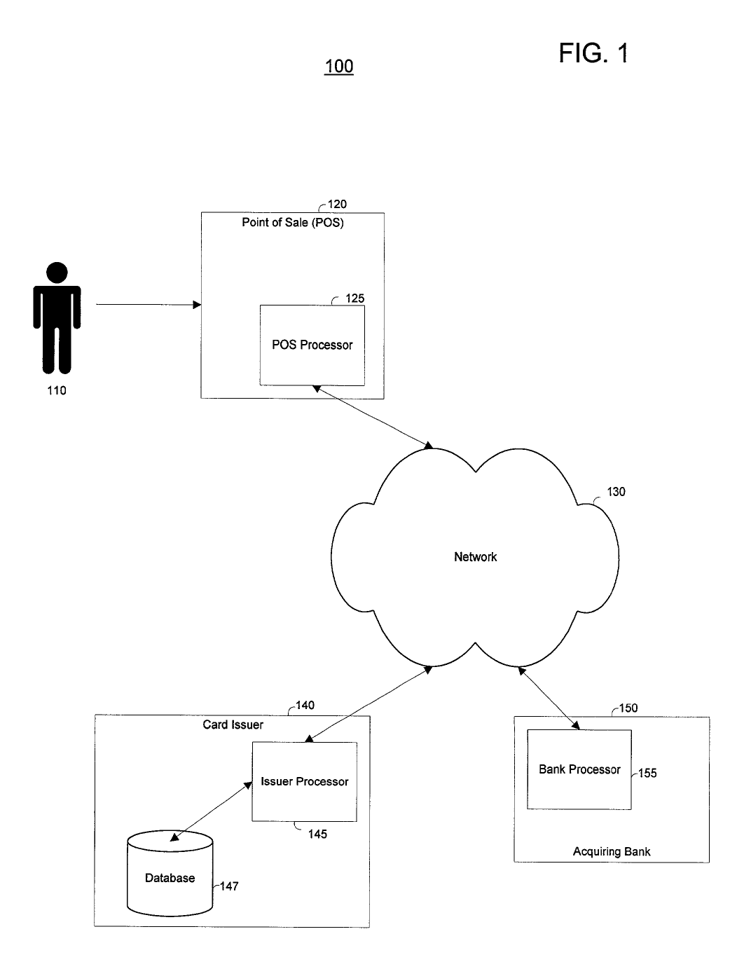

By way of a non-limiting example, FIG. 1 illustrates a system 100 in which the features and principles of the present invention may be implemented. As illustrated in the block diagram of FIG. 1, system 100 includes a customer 110, a point-of-sale (POS) location 120, a network 130, a card issuer 140, and an acquiring bank 150. Customer 110 is preferably an individual having a credit card account, but may also be an organization or other entity having such an account. Customer 110 interacts with the POS location 120 to transfer value to the card issuer 140.

POS location 120 includes any merchant connected to network 130. For example, POS location 120 may include retail stores, service providers, ATM machines, or any other business that is equipped to accept credit card transactions. POS location 120 further includes a POS processor 125 used to obtain credit transaction information from customer 110 and to transmit that information to other entities connected to network 130. In systems consistent with the present invention, POS 120 may also receive payments to the outstanding balance of credit card accounts of customers 110. POS location 120 is connected to card issuer 140 and acquiring bank 150 through network 130. Network 130 may include any data network, such as, for example, an existing secure credit network, a local area network (LAN), a public telephone switching network, an automated clearing house (ACH) network, or a wide area network, such as the Internet.

Card issuer 140 may be a bank, financial institution, or any other organization that provides a credit card to customer 110. Card issuer 140 further includes a processor 145 and a database 147. Issuer processor 145 may verify and process credit transactions for credit cards issued by card issuer 140. Database 147 contains account information, such as identifying data and account balance, for each customer having a credit card issued by card issuer 140. Card issuer 140 receives request from POS location 120 to verify and initiate credit card transactions.

For example, in a typical purchase-for-credit transaction, customer 110 presents a credit card issued by card issuer 140 to purchase goods or services at POS location 120. POS processor 125 gathers credit account information and generates a request for a transaction. POS processor 125 then sends this request through network 130 to card issuer 140, where the request is received by issuer processor 145. Issuer processor 145 accesses database 147 to verify data about the status of the credit account of customer 110. Based on the accessed information, issuer processor 145 then may approve the requested transaction based on that data. Issuer processor 145 acknowledges any approval or denial by sending a message through network 140 back to POS processor 125.

When transferring funds from a point-of-sale location, consistent with the present invention, customer 110 presents a credit card issued by card issuer 140 and an amount of funds to be transferred at POS location 120. POS processor 125 gathers credit account information and generates a request for a transaction, where the request includes an indication that the transaction includes a transfer and the amount of funds to be transferred. POS processor 125 then sends this request through network 130 to card issuer 140, where the request is received by issuer processor 145. Issuer processor 145 accesses database 147 to verify data about the status of the credit account of customer 110. Based on the accessed information, issuer processor 145 then may approve the requested transaction based on that data. Issuer processor 145 acknowledges any approval or denial by sending a message through network 140 back to POS processor 125. The message sent by issuer processor 145 may also include acknowledgement that the customer's account was credited by the transferred amount. Card issuer 140 finally credits customer's account in database 147.

Acquiring financial institution 150 may be any financial institution, such as a bank, connected to network 130. Most POS locations 120 do not interact with the card issuer directly to handle many of the operations required to complete a credit card transaction; thus, POS location 120 contracts with acquiring bank 150 for these tasks. For example, acquiring bank 150 may facilitate the clearance and settlement of receipts and funds between the POS location 120 and the card issuer 140 by receiving receipts, reimbursing POS location 120 for the amount of the transactions, and then seeking reimbursement from card issuer 140. Acquiring bank 150 may receive receipts from POS location 120 for each transaction. Acquiring bank 150 may then provide accounting services with respect to these transactions. For example, acquiring bank 150 may receive receipts indicating purchases made at POS location 120, for which funds should be transferred from card issuer 140 to POS location 120. Acquiring bank 150 may also receive receipts indicating fund transfers made at POS location 120, for which funds should be transferred from POS location 120 to card issuer 140. Acquiring bank 150 then may aggregate all of these transactions and provide a grand total to be transferred from card issuer 140 to POS location 120, or vice versa. Acquiring bank 150 includes bank processor 155 for handling these transactions. Alternatively, POS location 120 and card issuer 140 may complete fund transfer transactions directly, without the use of acquiring bank 150.

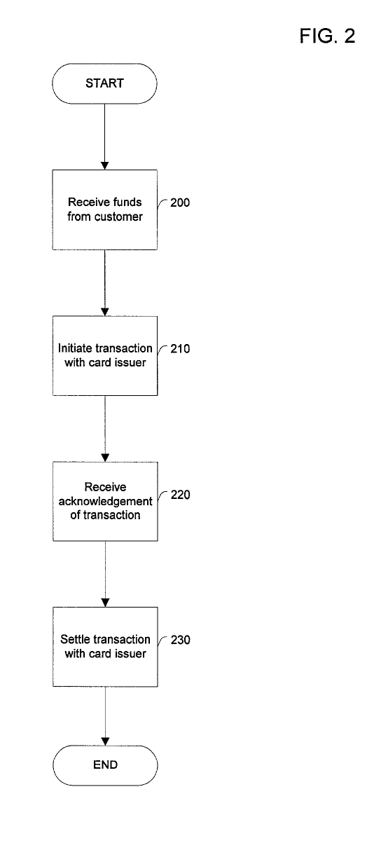

FIG. 2 is a flow diagram of a process consistent with one embodiment of the present invention for managing value transfer requests received at POS location 120, where network 130 is an existing credit network. As shown in FIG. 2, an operator at POS location 120 receives from customer 110 funds to be applied to the outstanding balance of a credit card account (step 200). Funds to be transferred to the account may include cash, cash equivalents (e.g., money order), a check, or a transfer from another credit card. Customer 110 may also present a credit card associated with the credit card account to which funds are being transferred to identify the account. Further, the invention is not limited merely to credit cards and credit card accounts, but also includes debit cards and stored value cards and their associated accounts. Alternatively, the invention may use a card similar in look and feel to a credit card but specifically designed for deposit transactions. Customer 110 may transfer funds as a sole payment transaction, or may purchase goods or services in addition to transferring value to the outstanding balance.

The operator at POS location 120 will then initiate the payment with card issuer 140 (step 210) through the network 130. For example, the operator may swipe the credit card through an automatic card reader, or may manually key the card information, such as the account number and/or expiration date, into POS processor 125. Additionally, the operator may key in a special transaction function or code indicating that the transaction includes a value payment transfer, as well as the amount of money to be transferred to the outstanding balance of the account.

The operator at POS location 120 then waits to receive acknowledgement of the transaction from card issuer 140 (step 220). Card issuer 140 will send an authorization message through network 130 indicating that the account exists and that the transferred amount has been credited to the customer's account.

POS location 120 may then provide customer 110 with a receipt or other indication of the transfer. Additionally, the customer may be charged a nominal service charge for this convenience. If a service charge exists, the customer may pay the service charge directly to the POS location 120, or the service charge may be deducted by the card issuer 140 before crediting the customer's account.

POS location 120 then forwards the funds to card issuer 140 (step 230). The funds may not be forwarded directly to card issuer 140, however. For example, POS location 120 may first forward the funds to acquiring bank 150 via a credit slip. Acquiring bank 150 determines the portion of the funds to be applied to purchased goods or services and the portion to be transferred to card issuer 140 for payment on the account. Additionally, acquiring bank 150 may determine whether the POS location 120 receives a portion of the amount transferred as a fee for handling the transaction. Acquiring bank 150 then will net the amounts to be transferred to card issuer 140 and the credit purchase amounts (to be received from card issuer 140), and will forward this data to the card issuer 140. In any event, acquiring bank 150 forwards the amount to be transferred to card issuer 140 as payment to be credited to the account. Additionally, bank processor 155 may create an electronic report, accounting for all transactions associated with card issuer 140 over a predetermined time frame, thus providing an additional level of security to both customer 110 and card issuer 140.

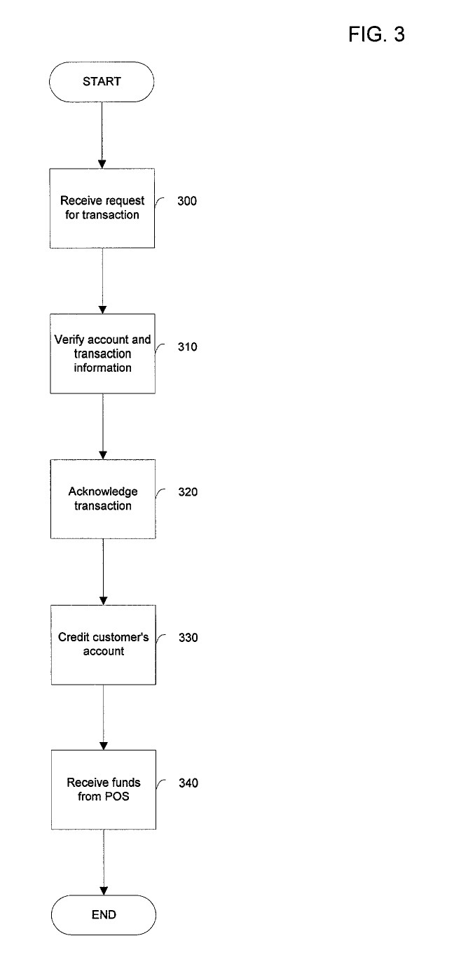

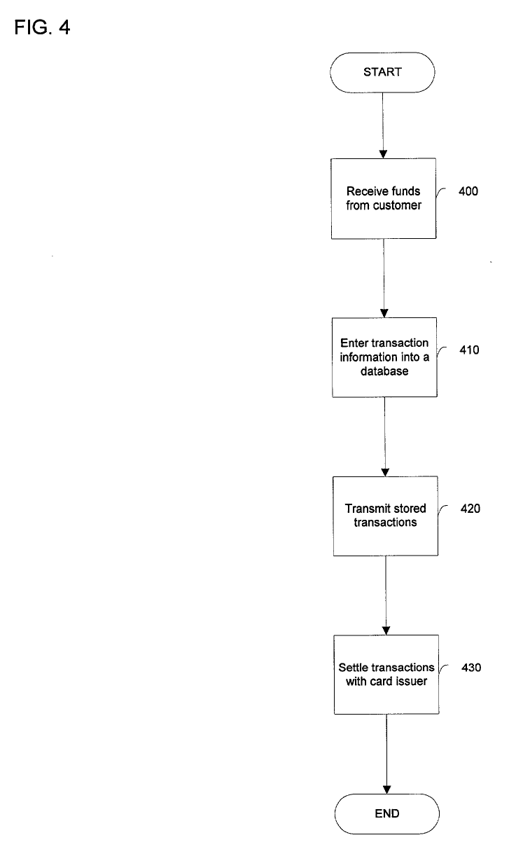

FIG. 3 is an exemplary flowchart of one embodiment of a process, consistent with the present invention, for receiving value transfer requests from POS location 120, where network 130 is an existing credit network. As shown in FIG. 3, issuer processor 145 receives a request for value transfer over network 130 (step 300). The request may include account identifying information (such as credit card number and expiration date), the transaction amount, and a function identifier indicating a value-transfer transaction. The function identifier allows for tracking and accounting of the transaction among participating entities (e.g. POS location 120, card issuer 140, and acquiring bank 150). Next, issuer processor 145 accesses database 147 to verify the account and transaction information, such as whether the account exists and whether the account may accept fund transfers (step 310). This verification ensures that the customer has a valid account with card issuer 140 and that the account can be credited with the payment amount included in the received request.

Issuer processor 145 then sends an authorization message to POS processor 125 (step 320). The acknowledgement message indicate whether the transaction was approved, whether the account exists, and whether the account was credited. Issuer processor 145 will credit customer's account (step 330). Finally issuer processor 145 receives the amount of money deposited by customer 110 at POS location 120 (step 340).

As described above, acquiring bank 150 preferably handles the settling of accounts between card issuer 140 and POS location 120. As discussed above, the acquiring bank will net all of the purchases and deposits made at POS location 120 that are associated with card issuer 140, and will forward the amount of money due to card issuer 140.

Alternatively, network 130 may be an electronic payments network, such as an automated clearing house (ACH) network. FIG. 4 is an exemplary flowchart illustrating one embodiment of a process, consistent with the present invention, where network 130 may be an ACH network. As illustrated in FIG. 4, the POS location 120 first receives funds from customer 110 (step 400). As above, the funds may include cash, check, credit card, or cash equivalents, such as money orders. Customer 110 may also present a credit card, debit card, stored value card, or a card specific to deposit transactions.

An operator at POS location 120 then enters information about the transaction into a database (step 410). The database (not shown) may be at either the POS location 120 or at a remote location on network 130. The information entered may include the account number to be credited and the dollar amount of the funds presented by customer 110.

At a designated time, all of the stored transactions entered at POS 120 are transmitted through the network 130 to card issuer 140 (step 420). The stored transactions may first be transmitted through the network 130 to a processor (not shown), which may determine which transactions are associated with a particular card issuer. The processor would then forward the corresponding transactions to card issuer 140. Once received, the transactions are settled, as described above, between the POS location 120 and card issuer 140 (step 430).

An additional alternative embodiment would permit transactions directly between POS location 120 and card issuer 140. In this case, transaction information would be transmitted through network 130, where network 130 includes a hard-line data-network (e.g., a local area network) or the Internet. This option may permit real-time transactions, as an operator at POS location 120 may have direct access to database 147 of card issuer 140.

It should be understood, however, that each embodiment of network 130, including credit networks, ACH networks, hard-line data networks, or the Internet, may provide different advantages and disadvantages, such as real-time transactions or direct access to database 147 of card issuer 140. One or more of these embodiments may be available at a particular POS location 120, permitting customer 110 to choose the embodiment that is best suited to their need.

It will be apparent to those skilled in the art that various modifications and variations can be made to the invention without departing from the scope or spirit of the invention. For example, rather than being associated with a credit card account, the customer may use the remote POS value-transfer method to add money to a debit card (associated with a checking account) or a stored value card. In this case, the ability to add money to these accounts provides a sort of “branch” office of the customer's bank that may be more convenient to the customer. An alternative embodiment would provide a method, using a credit card or debit card issued by card issuer 140, to make deposits into a CD or money market account (MMA). While the credit card or debit card may not be directly associated with the CD or MMA, the card issuer could provide a link between the card and those financial accounts to provide this service to the customer. Again, this would provide a convenience, similar to a branch bank location to the customer.

The above-noted features and other aspects and principles of the present invention may be implemented in various system or network environments to provide automated computational tools to facilitate processing of value transfer requests. Such environments may be specifically constructed for performing various processes and operations of the invention or they may include a general purpose computer or computing platform selectively activated or reconfigured by program code to provide the necessary functionality. The processes disclosed herein are not inherently related to any particular computer or apparatus, and may be implemented by a suitable combination of hardware, software, and/or firmware. For example, various general purpose machines may be used with programs written in accordance with the teachings of the invention, or it may be more convenient to construct a specialized apparatus or system to perform the required methods and techniques. The present invention also relates to computer readable media that include program instruction or program code for performing various computer-implemented operations based on the methods and processes of the invention. The media and program instructions may be those specially designed and constructed for the purposes of the invention, or they may be of the kind well-known and available to those having skill in the computer software arts. Examples of program instructions include both machine code, such as produced by a compiler, and files containing a high level code that can be executed by a computer using an interpreter.

Other modifications and embodiments of the invention will be apparent to those skilled in the art from consideration of the specification and practice of the invention disclosed herein. Therefore, it is intended that the specification and examples be considered as exemplary only, with a true scope and spirit of the invention being indicated by the following claims.

What is claimed is:

1. A method for transferring funds to a financial account from a point-of-sale location, wherein the transferred funds are applied to the account as a payment to the financial account, the method comprising:
receiving, at the point-of-sale location, funds from a holder of the financial account as a payment amount to the account;
forwarding to an issuer of the financial account a transaction message indicating a payment transaction and the received payment amount;
receiving an indication from the account issuer that the payment amount was applied to the financial account; and
forwarding the received funds to the account issuer upon receiving the indication that the payment was applied to the financial account.

2. The method of claim 1, wherein the funds received include at least one of cash, check, credit card, money order, or cashier's check.

3. The method of claim 1, wherein the step of receiving funds further comprises the step of:
receiving a credit card to identify the financial account.

4. The method of claim 1, wherein the step of forwarding received funds comprises the steps of:
forwarding the received funds to a financial institution, wherein the financial institution manages transactions of the point-of-sale location; and
forwarding the received funds, from the financial institution to the account issuer.

5. A method for receiving a payment to a financial account from a holder of the account via a point-of-sale location, the method comprising:
receiving, from the point-of-sale location, a transaction message indicating a payment transaction and an amount of the payment to the financial account;
verifying account information associated with the transaction indicated in the received transaction message;
sending to the point-of-sale location an indication that the transaction was approved and the payment amount was applied to the account; and
applying the payment amount to the account.

6. The method of claim 5, wherein the step of applying the payment amount includes the step of:
crediting a credit card account associated with the customer.

7. The method of claim 5, wherein the step of applying the payment amount includes the step of:
crediting a debit account associated with the customer.

8. The method of claim 5, wherein the step of applying the payment amount includes the step of:
crediting a stored-value account associated with the customer.

9. The method of claim 5, wherein the step of applying the payment amount includes the step of:
crediting a money market account associated with the customer.

10. The method of claim 5, wherein the step of applying the payment amount includes the step of:
crediting a certificate of deposit (CD) account associated with the customer.

11. The method of claim 5, wherein the step of applying the payment amount includes the step of:
receiving funds from the point-of-sale location.

12. The method of claim 11, wherein the step of receiving funds from the point-of-sale location includes receiving funds from a financial institution, wherein the financial institution manages the transactions of the point-of-sale location.

13. A system for transferring funds to a financial account from a point-of-sale location, wherein the transferred funds are applied to the account as a payment to the financial account, the system comprising:
means for receiving, at the point-of-sale location, funds from a holder of the financial account as a payment amount to the account;
means for forwarding to an issuer of the financial account a transaction message indicating a payment transaction and the received payment amount;
means for receiving an indication from the account issuer that the payment amount was applied to the financial account; and
means for forwarding the received funds to the account issuer upon receiving the indication that the payment was applied to the financial account.

14. The system of claim 13, wherein the means for forwarding a transaction message comprises a credit card network.

15. The system of claim 13, wherein the means for forwarding a transaction message comprises the Internet.

16. A system for receiving a payment to a financial account from a holder of the account via a point-of-sale location, the method comprising:
means for receiving, from the point-of-sale location, a transaction message indicating a payment transaction and an amount of the payment to the financial account;
means for verifying account information associated with the transaction indicated in the received transaction message;
means for sending to the point-of-sale location an indication that the transaction was approved and the payment amount was applied to the account; and
means for applying the payment amount to the account.

17. The system of claim 16, wherein the means for receiving a transaction message comprises a credit card network.

18. The system of claim 16, wherein the means for receiving a transaction message comprises the Internet.

19. A method for transferring funds to a financial account from a point-of-sale location, wherein the transferred funds are applied to the account as a payment to the financial account, the method comprising:
receiving, at the point-of-sale location, funds from a holder of the financial account as a payment amount to the account;
storing data about a funds transfer transaction, including information about the financial account and the received payment amount;
forwarding, at a predetermined time, the stored transaction data; and
forwarding the received funds to the account issuer based on the forwarded transaction data.

20. The method of claim 19, wherein the funds received include at least one of cash, check, credit card, money order, or cashier's check.

21. The method of claim 19, wherein the step of forwarding the stored transaction data includes the step of:
forwarding the stored transaction data to a processor;
determining, by the processor, the card issuer associated with the transaction data; and
forwarding, by the processor, the transaction data to the determined card issuer.

22. The method of claim 19, wherein the step of receiving funds further comprises the step of:
receiving a credit card to identify the financial account.

23. A system for transferring funds to a financial account from a point-of-sale location, wherein the transferred funds are applied to the account as a payment to the financial account, the system comprising:
means for receiving, at the point-of-sale location, funds from a holder of the financial account as a payment amount to the account;
means for storing data about a transaction, including information about the financial account and the received payment amount;
means for forwarding, at a predetermined time, the stored data about the transaction; and
means for forwarding the received funds to the account issuer upon receiving indication that the payment was applied to the financial account.

24. The system of claim 23, wherein the means for forwarding the stored data include an automated clearing house (ACH) network.
